(19) United States
(12) Patent Application Publication
(10) Pub. No.: US 2010/0143743 A1
(43) Pub. Date: Jun. 10, 2010

(54) STAINLESS STEEL SUBSTRATE WITH CONDUCTIVE METAL LAYER, HARD DISK SUSPENSION MATERIAL AND HARD DISK SUSPENSION MANUFACTURED BY USING THE MATERIAL

(75) Inventors: Yoshito Yamasaki, Tokyo (JP); Jun Nakatsuka, Tokyo (JP); Shuji Nagasaki, Tokyo (JP); Tooru Inaguma, Chiba (JP); Yuji Kubo, Chiba (JP); Tsutomu Sugiura, Chiba (JP)

Correspondence Address: DARBY & DARBY P.C., P.O. BOX 770, Church Street Station, New York, NY, 10008-0770, US

(73) Assignee: NIPPON STEEL MATERIALS CO., LTD., Tokyo (JP)

(21) Appl. No.: 12/089,405

(22) PCT Filed: Jan. 26, 2007
(86) PCT No.: PCT/JP2007/051751

§ 371 Date: Apr. 21, 2008

(30) Foreign Application Priority Data
Feb. 15, 2006 (JP) 2006-037808

(51) Int. Cl. B32B 15/00; B32B 3/00; B32B 15/08

(52) U.S. Cl. 428/601; 428/677; 428/626; 428/623

(57) ABSTRACT

A stainless steel substrate with one or more conductive metal layers, a method for manufacturing the same, and a hard disk drive suspension material using the same that are excellent in etching accuracy and does not involve the use of any substances casing environmental burdens, while ensuring stable adhesion between the conductive metal layers on the stainless steel substrate and the polyimide-based resin layer. The conductive metal layers are formed to have a total thickness ranging from 0.1 to 10 ?m, a centerline average surface roughness Ra from 0.05 to 1 ?m, and a ten-point average surface roughness Rz from 1 to 5 ?m, respectively.

### TECHNICAL FIELD

The present invention relates to a hard-disk suspension, a hard disk suspension material and a stainless steel substrate with conductive metal layer(s) required for meeting the needs for higher capacity and access rate.

### BACKGROUND ART

Conventionally, a hard disk drive (hereinafter abbreviated as HDD) includes inside a casing thereof principal members, such as a magnetic head, a load beam and a suspension, serving as members for use in a system for reading signals from a magnetic disk.

Among them, the mainstream structure of the load beam and the suspension has been one where the magnetic head is retained properly and stably along with an electric circuit for transfer of information signals. A specific example thereof is the one where a substrate comprising a hard stainless steel base; and an insulating resin layer formed thereon is provided, and then an electrically conductive metal foil such as a copper foil is formed on an upper layer of the substrate (see Non-patent document 1).

As a conventionally known art to provide the above structure, there is a suspension member for use with HDD, said suspension member being the one where a substrate comprising a stainless steel foil; and an insulating resin layer formed directly on the foil is provided, and then an electrically conductive metal layer is formed on an upper layer of the substrate. One of typical representatives of such substrates is a stainless steel foil/polyimide based resin layer (see Non-patent document 2).

However, due to increasing needs for higher capacity of HDD as well as the progress in increase of transfer rate in the suspension in response to the increased transfer rate and accesses to recorded information, it is becoming increasingly difficult to employ the foregoing conventional structure.

In other words, in order to increase the signal transfer rate in the suspension, it is necessary to realize so-called impedance matching, for the purpose of which it is imperative to ensure high electrical conductance not only in the conductive metal layer as the upper layer of the insulating layer but also in the stainless steel base as the lower layer thereof. According to the conventional stainless steel base (or foil)/insulating resin layer/conductive metal layer structure, however, it is impossible to ensure that effect.

Accordingly, to remedy the above problem, there have arisen some needs to provide a conductive metal layer on the stainless steel base, and then to form an insulating resin layer thereon (see patent document 1, for example.)

For the above-mentioned purpose, when a conductive metal layer is provided on a stainless steel base to form a substrate, and then an insulating resin layer such as a polyimide-based resin layer is provided thereon, in other words, when the substrate comprises a stainless steel foil/conductive metal layer/polyimide-based resin layer, there occur the following problems:

Namely, whilst interfacial adhesion between a stainless steel foil and a polyimide-based resin layer can be ensured fully due to the good affinity of the former for the latter, it is not easy to ensure high adhesion between a polyimide-based resin and a conductive metal. This is because the affinity of a conductive metal layer (such as a copper layer) for a polyimide-based resin layer is so poor that the adhesion is difficult to ensure between the two layers as they are, although high adhesion between a stainless steel foil and an organic resin layer can be ensured because the surface of stainless steel foil is covered with a metal oxide coating such as that of iron or chromium so that intermolecular interaction with the organic resin can occur.

In order to ensure adhesion between a copper layer and a polyimide-based resin layer, typically two methods have been conventionally known: one is a nodule forming method to form nodules on a surface of the copper layer so as to produce the anchoring effect (see patent document 2); and the other is a chromate treatment to enhance affinity.

However, due to the thickness of the conductive metal layers provided on the stainless steel base being too small, it was difficult to form nodules on the surface of copper so as to produce the anchoring effect. Moreover, even when such nodules were formed, yet decrease in etching accuracy was unavoidable due to the size of irregularities of the nodules.

Moreover, use of chromate treatment or the like is being regulated because it uses environmentally hazardous substances.

Against such a background, it has been long wanted to provide a stainless steel substrate with one or more conductive metal layers for use with a HDD suspension that is excellent in etching accuracy and does not involve the use of any environmentally hazardous substances, while ensuring stable adhesion between the conductive metal layers on the stainless steel base and an insulating resin layer such as a polyimide-based resin layer.

Patent Document 1: Japanese Un-Examined Patent Publication No. 2003-152404

Patent Document 2: Japanese Un-Examined Patent Publication No. 11-61440

Non-Patent Document 1: FUJITSU by Mizoshita, Vol. 50, No. 1, PP. 14-21, 1999

Non-Patent Document 2: FUJIKURA GIHO by Shimomura et al., No. 99, P 72-76, 2000

### DISCLOSURE OF THE INVENTION

### Problems to be Solved by the Invention

It is, therefore, an object of the present invention to provide a hard-disk suspension and principal structural members thereof, required for meeting the needs for higher capacity and access rate, specifically enabling the provision of a stainless steel substrate with one or more conductive metal layers, a hard disk suspension material using such substrate, and a hard disk suspension manufactured by using the material that are excellent in etching accuracy and do not involve the use of any environmentally hazardous substances, while ensuring stable adhesion between the conductive metal layers on the stainless steel base and the insulating layer such as polyimide-based resin layer.

### Means for Solving the Problems

The inventors of the present invention studied the foregoing problems carefully and have found out that they can be solved by optimal control of the thickness of the conductive metal layers provided on the stainless steel base, while setting the surface roughness thereof to have certain optimal ranges, through a step of subjecting the conductive metal layers to plating or cladding rolling treatment in an optimal manner.

According to a first aspect of the invention, there is provided a stainless steel substrate with one or more conductive metal layers provided on a stainless steel base, wherein said one or more conductive metal layers have a total thickness ranging from 0.1 to 10 μm, a centerline average surface roughness Ra from 0.05 to 1 μm, and a ten-point average surface roughness Rz from 1 to 5 μm, respectively.

According to a second aspect of the invention, there is provided a stainless steel substrate according to the first aspect, wherein said conductive metal layers comprise a plated layer of at least one conductive metal.

According to a third aspect of the invention, there is provided a stainless steel substrate according to the first aspect, wherein said conductive metal layers comprise one or more conductive metal foils composed of at least one conductive metal, said one or more conductive metal foils being rolled onto a surface of said stainless steel base by a cladding rolling treatment, and wherein said surface roughness is that of a top surface of said metal foils.

### Effects of the Invention

According to the present invention, there can be provided a stainless steel substrate with one or more conductive metal layers for use with a hard disk drive suspension that is excellent in etching accuracy and does not involve the use of any environmentally hazardous substances, while ensuring stable adhesion between the conductive metal layers on the stainless steel base and the polyimide-based resin layer.

According to the present invention, there can be also provided a hard disk suspension material and a hard disk suspension required for meeting the needs for higher capacity and access rate of HDD.

### BRIEF DESCRIPTION OF THE DRAWINGS

FIG. 1 is a SEM image of a copper-plated surface in accordance with an example of the invention.

FIG. 2 is another SEM image of a copper-plated surface in accordance with a comparative example of the invention.

FIG. 3 is section of a laminated body composed of four main layers in accordance with the embodiment of the invention.

### BEST MODE FOR CARRYING OUT THE INVENTION

Next is a detailed description of the present invention.

First, it will be described in detail what is requirement for a stainless steel substrate with a conductive metal layer for use with HDD suspension in accordance with the present invention.

The stainless steel substrate with one or more conductive metal layers for use with HDD suspension of the present invention includes one or more conductive metal layers on a stainless steel base, on which are laid single or multi layers of insulating resin layers made of polyimide-based resin and metal foil layers such as copper foils, thereby providing a material used as a suspension.

Although the stainless steel base as one of structure members of a laminated body used for the stainless steel substrate is not specifically limited, but it may be one that contains not less than 12 percent by mass of chromium as a principal component, and forms a passive film automatically in the atmosphere to thereby maintain corrosion resistance and weather resistance. Preferable stainless steel from a standpoint of spring characteristic or dimensional stability required for a suspension is either SUS304 or SUS301, more preferably SUS304 or SUS301 that has underwent tension annealing treatment at 300 degrees C. or above.

In order to strengthen adhesion between the stainless steel base and the one or more conductive metal layers provided thereon, and in order to ensure good adhesion between the top of the metal layers and the insulating resin layer, the thickness and surface roughness Ra and Rz of the conductive metal layers are kept in optimal ranges, which provides a subject matter of the invention.

The conductive metal layers formed on the stainless steel base of the present invention may be preferably ones of copper, silver or other conductive metals, or metal plating, etc. of which the total thickness ranging from 0.1 to 10 μm, although it depends on a type of a magnetic head to which the invention is applied, a recording system, a data transfer rate, a preamplifier, or design of circuit pattern such as circuit length on the metal foil layer, a wiring interval, etc.

If the total thickness of the conductive metal layers is too small to be within the above range, electrical conductance required for the impedance matching can not be obtained, while if it is too large to be within the above range, then the total thickness of the members becomes too large, causing a design problem, and thus it is not appropriate.

What is referred to as “the thickness of the conductive metal layers” herein is the thickness of the conductive metal layer(s) uniformly formed on the stainless steel base. Such thickness is obtained directly by cross-sectional observation of the members using a scanning electron microscope (SEM). That is, thickness measurement at about ten points is performed at random within a measured view for the scanning microscope observation of a sample, and an average value thus obtained is defined as the total thickness of the conductive metal layers.

The surface roughness of the stainless steel substrate with one or more conductive metal layers of the present invention satisfies the conditions that Ra should range from 0.05 to 1 μm, and Rz from 1 to 5 μm, respectively. When Ra is less than 0.05 μm or Rz is less than 1 μm, good adhesion between the stainless steel substrate and the insulated resin layer cannot be obtained.

When Ra is more than 1 μm, or Rz is more than 5 μm, then a clearance is enclosed when providing the resin layer, or etching accuracy is decreased due to uneven surface of the resin layer surface. As a result, there occurs a problem that a good material for a hard disk suspension can not be obtained.

The surface roughness employed here is defined in accordance with MS B0601-1994, in which Ra is arithmetic average roughness and Rz is maximum height. Ra and Rz may be measured by using various kinds of surface roughness measuring instruments including stylus type or non-contact type roughness meters, such as surface roughness meter NT1000 available from Veeco Instruments Inc. and Surfcoder SE-1700 available from Kosaka Laboratory Ltd.

As described above, according to the stainless steel substrate with one or more conducive metal layers of the invention, the requirements for improving adhesion between the stainless steel base and the one or more conductive metal layers provided thereon, and for ensuring good adhesion between the top of the metal layers and the insulating resin layer, are to keep the thickness and surface roughness Ra and Rz of the conductive metal layers within specific optimal ranges, whereby there can be provided a hard disk suspension, its basic structure members required to meet the needs for higher capacity and access rate, as is referred to as an object of the present invention, specifically enabling the provision of a stainless steel substrate for hard disk drive suspension that is excellent in etching accuracy and contains no environmentally hazardous substances, while ensuring stable adhesion between the conductive metal layers on the stainless steel base and the resin insulating layers made of polyimide-based resin etc.

Furthermore, it is imperative that the conductive metal layers used for the stainless steel substrate with one or more conductive metal layers of the present invention should have high electric conductivity in order to produce the impedance matching effect in response to improvement in HDD data transfer rate.

Specifically, the conductive metal layers may preferably comprise one or more metal layers primarily composed of at least one metal having electric resistivity of 20 μΩcm or less, more preferably 10 μΩcm or less. For the numerical value of the electric resistivity specific to respective metals, dictionaries of physical and chemical terminology or other various handbooks may be referred to so as to select the conductive metal layers within the above specific range of electric resistivity.

If the conductive metal layers include no metal layer primarily composed of any metal having electric resistivity of 20 μΩcm or less, then the impedance matching effect is not fully achieved since the in-plane electrical resistance on the stainless steel foil as a HDD suspension member becomes too large.

Moreover, it is desirable that the one or more conductive metal layers used in the stainless steel substrate of the present invention have at least one metal layer primarily composed of at least one metal selected from a group consisting of copper, nickel, silver, gold, aluminum, tin and zinc.

Each of these metals is known to have a comparatively small electric resistivity, easily forming a surface-modified metal layer by plating etc., and involving less environmental burdens, thereby enabling the effect of the present invention to be obtained in a preferable manner.

What is meant by the phrase “metal layer primarily composed of (a certain specific) metal” is preferably the one that contains not less than 50% by mass of the specific metal.

Moreover, it is desirable that the one or more conductive metal layers used for the stainless steel substrate of the present invention have at least one metal layer primarily composed of copper.

This is because copper, as a metal, has high versatility and is comparatively inexpensive and excellent in balance of characteristics such as electrical conductance. Accordingly, the use of copper enables high electrical conductance to be imparted to the stainless steel substrate.

Alternatively, the conductive metal layers used for the stainless steel substrate of the present invention may comprise at least one metal layer primarily composed of copper and another metal layer primarily composed of any conductive metal other than copper.

By providing such metal layer primarily composed of any conductive metal other than copper, there can be achieved improvement of interface adhesion between the metal layer primarily composed of copper and the stainless steel base, control of the surface property of the copper layer, supplementation of electrical conductance, and degradation control in the interface between the copper layer and the stainless steel base.

In other words, it becomes possible to impart other functions, such as improvement of adhesion and durability in addition to the electrical conductivity on the surface of the stainless steel base as required for a HDD suspension member.

Whilst examples of the above-mentioned conductive metal primarily composed of copper may include generally well-known ones such as a 3 to 20 μm-thick copper foil, a copper alloy foil, a metal layer produced by copper plating, etc., an optimal thickness thereof may be selected according to a suspension stiffness design or circuit pattern design as well.

For a copper alloy, it is meant to be an alloy foil or alloy plating composed of copper and other element than copper such as nickel, silicone, zinc and beryllium, containing not less than 50% by mass of copper.

It should be noted that the electrical conductivity as a performance originally required when two or more conductive metal layers are formed is generally defined by the electrical conductivity of the metal layer primarily composed of copper and the thickness thereof. Accordingly, the metal layer serving as a primary component in the conductive metal layers should have superior electrical conductivity, and make up a large percentage, specifically not less than 50%, preferably not less than 80% of the 0.1 to 10 μm thickness of the one or more conductive metal layers prescribed by the invention.

For example, when the conductive metal layers formed on the stainless steel base comprise a copper layer and a nickel layer, it is desirable that the copper layer should make up a major portion thereof for the sake of the impedance matching, as is one of principal objects of the present invention, since the electrical resistivity of copper is 1.68 μΩcm and that of nickel is 6.99 μΩcm.

In that case, the main purpose of using the nickel layer is to manifest the adhesion between the stainless steel base and the copper layer, not to manifest the electrical conductivity. In that context, when the two or more conductive metal layers are provided for the conductive metal layer of the invention, and certain metals are used that are comparatively low in conductivity yet capable of being used for the invention, such as the aforesaid nickel or zinc having electrical resistivity of 6.02 μm, it is desirable to make these layers as thin as possible. Furthermore, it is even more preferable if electrically conductive metals in the form of particles or fillers are provided between these conductive metal layers.

The stainless steel base used in the stainless steel substrate with one or more conductive metal layers of the present invention may preferably have a thickness of 100 μm or below, more preferably 30 μm or below. If the thickness of the stainless steel base is more than 100 μm, there is a problem that not only reduction in size and weight of HDD and its components will become too difficult to achieve the effect of the present invention, but processing of components, such as cutting, etching, pressing, etc. will also become difficult. As for the minimum thickness of the stainless steel base, it may be thinner so long as no problems occur in terms of the stiffness design of suspension and the strength of components. From viewpoints of availability and manageability thereof, 10 μm or more would be preferred, but it shall not be specifically limited thereto.

Next is a description of a method of manufacturing the stainless steel substrate with one or more conductive metal layers of the present invention.

The stainless steel substrate with one or more conductive metal layers of the present invention can be obtained by plating the stainless steel base with one or more metals so as to provide one or more conductive metal layers having a total thickness ranging from 0.1 to 10 μm, a centerline average surface roughness Ra from 0.05 to 1 μm, and a ten-point average surface roughness Rz from 1 to 5 μm, respectively. The above-mentioned stainless steel substrate can be manufactured by providing the stainless steel base with a plating of such optimal thickness, and by controlling the post-plating surface roughness so as to be kept within such optimal ranges.

The term “plating” used here genetically names any processing that enables the formation of a uniform metal layer on a material surface, including electroplating, hot-dip plating, electroless plating, and a dry process such as vapor deposition.

The stainless steel base and plating equipment used for plating are not to be limited in particular but single foil processing system or continuous coil processing system may be chosen according to the needs. Moreover, it is preferable that the surface of the stainless steel base to be processed should undergo degreasing, cleaning and activating processing as a pretreatment so as to ensure adhesion between the same and the plating. The surface thus pretreated may further undergo electrolytic degreasing and electrolytic cleaning if necessary. As the need arises, a protective mask film or protective coating may be applied to a part of the surface of the stainless steel base where no conductive metal layer is to be provided in order that plating electrolyte may not enter and adhere thereto. Alternatively, such protective mask film or coating may be removed thereafter.

If the thickness of the one or more conductive metal layers formed of plating is less than 0.1 μm, then the electrical conductivity required for the impedance matching cannot be acquired, while if it is more than 10 μm, then the total thickness of the components becomes so large that there will occur a design problem, and thus it is not appropriate. For the surface roughness after the plating (i.e., post-plating surface roughness), if Ra is less than 0.05 μm or Rz is less than 1 μm, good adhesion to the insulating resin layer cannot be obtained.

If Ra is more than 1 μm, or Rz is more than 5 μm, surface roughness after forming the conductive metal layers by plating becomes too great, and thus a clearance will be enclosed when providing the resin layer, or etching accuracy will be decreased due to uneven surface of the resin layer surface. As a result, a good material for a hard disk suspension can not be obtained.

As for the control of the surface roughness of the plated surface, it is capable of being controlled satisfactorily by adjustment of the plating conditions, but it also depends on the surface roughness of the stainless steel base used. Although the stainless steel base prior to the plating process is not specifically limited, it is desirable that it should have a surface roughness equivalent to or less than the target surface roughness, and that the surface roughness of the stainless steel base be chosen according to needs so that the plated surface may have an optimal roughness. Alternatively, the target surface roughness may be obtained by subjecting the plated surface to chemical or mechanical treatment.

Furthermore, according to the stainless steel substrate of the present invention, it is desirable that said plated layer comprises a plated layer of at least one metal selected from a group consisting of copper, nickel, silver, gold, aluminum, tin, zinc and an alloy containing any of these metals. The plating of these metals is capable of being employed readily in the present invention in terms of their widespread use for various purposes and less environmental burdens.

Moreover, according to the stainless steel substrate with one or more conductive metal layers of the present invention, it is desirable that said conductive metal layer be the one primarily composed of copper. This is because composing the conductive metal layers primarily of copper enables high electrical conductance to be realized and the conductive metal layers to be manufactured at low cost.

Plating primarily composed of copper is capable of being employed readily in the present invention in terms of their widespread use for various purposes and less environmental burdens. Next is a detailed description of an example where copper is employed as a plating metal to form the conductive metal layers from copper.

For copper plating bath may be employed acid bath such as copper sulfate bath, copper fluoroborate bath, etc. or alkali bath such as copper cyanide bath, copper pyrophosphate bath, etc. which may be chosen in accordance with a necessary plating thickness and/or productivity, but it is desirable that defective plating such as burn or the like be removed and no brightener be added.

Applied current density at the time of copper plating ranges from about 10 to 30 A/cm² or so, which may be suitably chosen in terms of productivity, and then plating is carried out for a predetermined period of time so that the thickness of the copper plating and the surface roughness of the copper-plated surface may be adjusted so as to be within the above-mentioned optimal range, respectively.

According to another aspect of the invention, a method for manufacturing a stainless steel substrate with one or more conductive metal layers of the invention may comprise steps of applying a strike plating to a surface of said stainless steel base, and then plating the same with at least one conductive metal so that said one or more conductive metal layers may have a total thickness ranging from 0.1 to 10 μm, a centerline average surface roughness Ra from 0.05 to 1 μm, and a ten-point average surface roughness Rz from 1 to 5 μm, respectively.

According to the aspect of the invention, a strike plating as an intermediate layer is provided in order to improve adhesion between the conductive metal layers and the stainless steel base, in addition to the aforesaid requirements for the manufacturing of the present invention. Accordingly, the conductive metal layers of predetermined thickness are provided on the stainless steel base with the adhesion being realized, whereby the effect of the invention can be obtained while preventing the delamination of the conductive metal layers, etc.

In a preferable form of the invention, the strike plating performed in the method for manufacturing a stainless steel substrate with one or more conductive metal layers of the invention may be that of at least one metal selected from a group consisting of copper, nickel, silver, gold, aluminum, tin and zinc.

The strike plating using the above-mentioned metals enables high conductivity and high adhesion to be realized, thus obtaining the optimal effect of the present invention. In a case where a nickel strike plating is used, Watts bath, sulphamate bath, or both can be used together as nickel plating bath.

Plating thickness may be in a range of from 0.05 to 0.3 μm, which may be chosen so as to obtain optimal adhesion as required. Likewise, the same effect of the present invention can be obtained in a case where a strike plating using any of the above-mentioned metals than nickel is used.

According to a further aspect of the invention, the method for manufacturing a stainless steel substrate with one or more conductive metal layers of the invention may comprise steps of applying a strike plating to a surface of said stainless steel base, and then plating the same with at least one conductive metal so that said one or more conductive metal layers have a total thickness ranging from 0.1 to 10 μm, a centerline average surface roughness Ra from 0.05 to 1 μm, and a ten-point average surface roughness Rz from 1 to 5 μm, respectively, wherein said one or more conductive metal layers are primarily composed of copper.

Namely, the metal layer primarily composed of copper is formed after the strike plating is performed and then the surface roughness and total thickness of the conductive metal layers are controlled in the above-mentioned optimal manner, whereby it is possible to produce such conductive metal layers easily and at low cost that are excellent in balance of characteristics such as electrical conductance.

Alternatively, the plating in the method for manufacturing the stainless steel substrate with one or more conductive metal layers of the present invention may be electroplating. Electroplating makes it possible to implement quantitive control of a deposition amount based on current control in a highly-reproducible manner, while enabling the control of the surface roughness based on balance control between reaction time and electric current, thereby being capable of attaining the effect of the present invention more easily, as discussed in the foregoing paragraphs with regard to the use of copper as one of plating metals to form a copper layer in the conductive metal layers.

Alternatively, according to the method for manufacturing the stainless steel substrate with one or more conductive metal layers of the present invention, the stainless steel base may comprise a stainless steel foil having a thickness of 100 μm or less. As discussed in the foregoing paragraphs, it is preferable that the thickness of the stainless steel base as a component of the stainless steel substrate with one or more conductive metal layers of the present invention be 100 μm or less. Accordingly, the effect of the invention can be obtained easily by using the stainless steel base falling within this range of thickness.

According to a still further aspect of the invention, the method for manufacturing a stainless steel substrate with one or more conductive metal layers of the invention may comprise steps of providing one or more conductive metal foils composed of at least one conductive metal on the surface of the stainless steel base by cladding rolling treatment so that said one or more conductive metal layers have a total thickness ranging from 0.1 to 10 μm, and a top surface of said one or more conductive metal layers has a centerline average surface roughness Ra from 0.05 to 1 μm, and a ten-point average surface roughness Rz from 1 to 5 μm, respectively

The above-mentioned stainless steel substrate can be also manufactured by this cladding rolling treatment with the optimal thickness and controlling the post-treatment surface so as to be kept within the optimal ranges.

Thus, there can be provided the stainless steel substrate wherein said conductive metal layers comprise one or more conductive metal foils composed of at least one conductive metal, said one or more conductive metal foils being rolled onto a surface of said stainless steel base by a cladding rolling treatment, and wherein said surface roughness is that of a top surface of said metal foils.

The cladding rolling treatment employed herein is the one where two or more metal foils are laminated by cladding at the same time that the total thickness of the conductive metal layers is adjusted so as to be within a predetermined range. The cladding rolling treatment may include such a treatment as one where a treatment by a cold rolling mill is performed after a treatment by a cladding rolling mill so as to combine the former treatment with the latter.

If the thickness of the one or more conductive metal layers formed by cladding rolling treatment is less than 0.1 μm, then the electrical conductivity required for impedance matching cannot be acquired, while if it is more than 10 μm, then the total thickness of the components becomes so large that there will occur a design problem, and thus it is not appropriate. For the surface roughness after the cladding rolling treatment, if Ra is less than 0.05 μm or Rz is less than 1 μm, good adhesion to insulating resin layer cannot be obtained. If Ra is more than 1 μm, or Rz is more than 5 μm, surface roughness after forming the conductive metal layers becomes too great, and thus a clearance will be enclosed when providing the resin layer, or etching accuracy will be decreased due to uneven surface of the resin layer surface. As a result, a good material for a hard disk suspension can not be obtained.

As for the control of the surface roughness of the top surface after the cladding rolling treatment, it is capable of being controlled satisfactorily by optimizing the cladding rolling conditions and/or raw material metals. In addition, the target surface roughness may be obtained by subjecting the top surface after the cladding rolling treatment to chemical or mechanical treatment.

In a preferred form of the method for manufacturing a stainless steel substrate with one or more conductive metal layers of the invention, said conductive metal foils used in the cladding rolling treatment may comprise at least one metal foil composed of at least one metal selected from a group consisting of copper, nickel, silver, gold and aluminum. Since these metal foils are easily available as general-purpose industrial materials, and have high electrical conductance, the effect of the present invention can be obtained simply and reliably.

In a further preferred form of the method for manufacturing a stainless steel substrate with one or more conductive metal layers of the invention, said conductive metal foils used in the cladding rolling treatment may comprise a metal foil primarily composed of copper. This is because composing the conductive metal layers primarily of copper ensures high electrical conductance, and enables the conductive metal layers to be constituted at low cost.

Alternatively, according to the method for manufacturing the stainless steel substrate with one or more conductive metal layers of the present invention, the stainless steel base may comprise a stainless steel foil having a thickness of 100 μm or less in the method employing the foregoing cladding rolling treatment. As discussed in the foregoing paragraphs, it is preferable that the thickness of the stainless steel base as a component of the stainless steel substrate with one or more conductive metal layers of the present invention be 100 μm or less.

There are some concerns about the stainless steel base becoming a little too thin due to the cladding rolling. The stainless steel base, however, is harder than the conductive metal foils and thus less deformable, so that it suffers less influence therefrom, and that even if there is a reduction in thickness due to the slight deformation, it is self-evident that thickness of the stainless steel base as a component of the manufactured stainless steel substrate will have a thickness of 100 μm or less. Accordingly, using the stainless steel base having thickness of 100 μm or less enables the effect of the present invention to be obtained easily.

Although the method of manufacturing a stainless steel substrate with one or more conductive metal layers of the present invention is explained in detail as above, any other suitable method may be employed for the present invention, such as a method of forming the conductive metal layers on the stainless steel base using a gas-phase process, or a method of attaching the conductive metal foils onto the stainless steel base by adhesion using an adhesive or the like. It should be noted that any suitable method may be employed so long as the method meets the original purpose of the present invention, i.e., attaching a predetermined thickness of conductive metal layers onto a stainless steel base and allowing the surface thereof to have a predetermined range of surface roughness.

Next is a description of a hard disk suspension material according to the present invention.

A hard disk suspension material in accordance with the present invention comprises a laminated structure formed by laying an insulating layer and a metal foil layer in that order on the conductive metal layer on the stainless steel base.

Accordingly, there can be provided a suspension for hard disk, its basic structure members, and a production method thereof, required to meet the needs for higher capacity and access rate, as is referred to as an object of the present invention, enabling the provision of a stainless steel substrate for hard disk drive suspension that is excellent in etching accuracy and contains no environmentally hazardous substances, while ensuring stable adhesion between the conductive metal layers on the stainless steel base and the resin insulating layers made of polyimide-based resin etc.

In a preferred form of the hard disk suspension material of the present invention, adhesive strength between the insulating resin layer and the metal foil layer, and adhesive strength of that resin layer and the stainless steel base are preferably 0.5 kN/m or more, more preferably in a range from 1.0 to 4.0 kN/m.

Here, the term “adhesive strength” used here represents a numerical value expressed by 180 degrees peeling strength at normal temperature (25 degrees C.). If adhesive strength is less than 0.5 kN/m, peeling between metal foil and resin can easily occur in the manufacturing process of the suspension. Moreover, since variations in adhesive strength are expected at the time of the manufacture thereof, adhesive strength of 0.5 kN/m or more can more easily be insured stably if adhesive strength is set to 1.0 kN/m or more.

In a preferred form of the hard disk suspension material of the present invention, it is desirable that said insulating layer may comprise a single layer of either polyimide-based resin or resin primarily composed of polyimide-based resin, or otherwise, two or more layers of both resins. Polyimide and polyimide-based resin have the outstanding characteristics, such as high insulation properties, high heat resistance, and high dimensional stability, having good etching processability, and thus they are suited for the insulating layer of a hard disk suspension material.

The thickness of the resin layer may preferably range from 4 to 50 μm, more preferably from 4 to 30 μm, which however, should not be construed as limiting since an optimal layer thickness is selected by stiffness design of the suspension taking the relationship among a stainless steel substrate, conductive metal layers, copper foils and copper alloy foils into consideration.

For example, when using polyimide-based resin, monolayer or multilayer polyimide films prepared beforehand may be used and then they may be formed into a laminated body by thermal compression boding. Alternatively, polyimide-based resin solution may be applied by a coating method and dried and heat treated, and then it may be formed into a laminated body by thermal compression boding. Each method enables a desired thickness and adhesion to be obtained, and thus it may be employed.

For example, for the method of forming a polyimide-based resin layer on a stainless steel substrate with one or more conductive metal layers, applying and drying of a polyimide-based resin solution are repeated, which is then heat treated at high temperature of 200 degrees C. or more, and metal foils are applied thereto by thermal compression bonding. In that case, if the content of polyimide-based resin as the insulating layer is 50 percent by mass or above, then the effect of the present invention can be obtained even if it is combined with other resin, or forms a clad layer with other alloyed film or resin film.

Furthermore, the present invention further relates to a hard disk suspension produced by processing and shaping any of the foregoing hard disk suspension materials. That is, the hard disk suspension material of the present invention is applicable as a material of a hard disk suspension as a main component of HDD.

The phrase “processing and shaping of hard disk suspension material” mentioned above generically includes every necessary treatment such as shaping of components by etching, forming of electric circuits, electric connections, mechanical connections, mounting of them onto a casing, fixing, various safety ensuring treatment, corrosion-proofing treatment, etc. The hard disk suspension produced thus way includes all the properties required for meeting the needs for higher capacity and access rate, as is referred to as the object of the present invention.

As is discussed above, the present invention enables the provision of a hard disk drive suspension required for meeting the needs for larger capacity and higher access rate, its basic structure members, and a production method thereof. Specifically, according to the present invention, there can be provided a stainless steel substrate for hard disk drive suspension, components of such hard disc drive suspension having metal foil layers on its substrate, as well as the production method thereof that are excellent in etching accuracy, containing no substances that cause environmental burdens, while ensuring excellent adhesion between the conductive metal layers and the polyimide insulating layer on the substrate.

### EXAMPLES

Next is a detailed description of the invention with reference to actual examples.

The thickness of the conductive metal layer in this example was measured by direct observation of a section of a sample, using a scanning electron microscope (SEM), said sample being embedded in epoxy resin and then ground. The thickness of each structural layer was determined by microphotographs thus obtained. For one sample, measurement of thickness was carried out 10 times in different fields of view, and thus an average value was calculated.

The surface roughness Ra and Rz in the example was determined, using NT1000 available from Veeco Instruments Inc.

### First Example

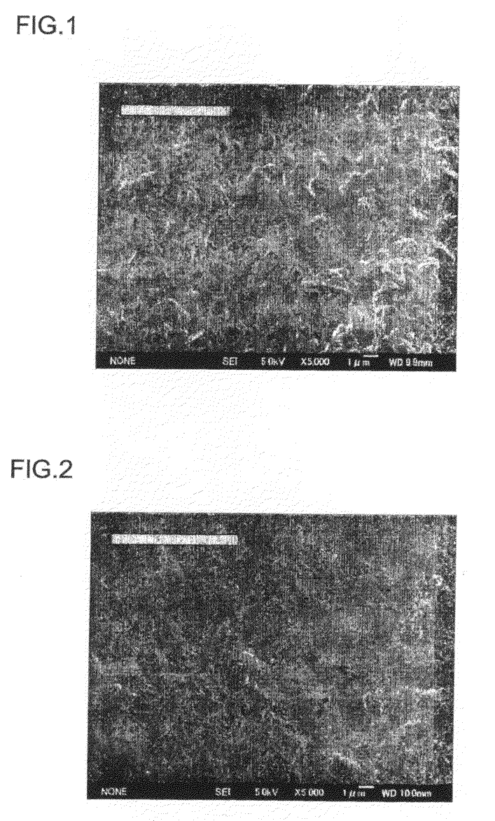

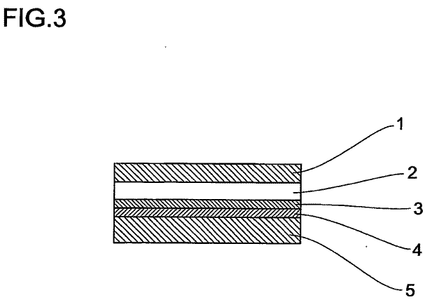

After applying nickel strike plating to a stainless steel foil, pure copper layer was formed as a conductive metal layer by electroplating method, and thus a stainless steel substrate with one or more conductive metal layers was manufactured. FIG. 1 shows a SEM image of a copper-plated surface of the obtained stainless steel substrate.

For electroplating of the conductive metal layer was used a SUS304 stainless steel foil coil as a sample material, which was 20 μm in thickness, 220 μm in width, and 0.12 μm in Ra and 0.8 μm in Rz, respectively. The sample material was then subjected to degreasing cleaning, nickel strike plating, copper plating, water washing and drying, in sequence. For the nickel strike plating were used Watts bath and sulfamate bath as 50-degree C. plating bath, while for copper plating bath was used copper sulfate bath of normal temperature, containing no brightener as an additive. Current density in the copper plating process was set to 20 A/dm².

As for the thickness of the obtained conductive metal layers of the stainless steel substrate, the nickel plated layer was 0.05 μm thick, while the copper plated layer 2.5 μm thick. As for the surface roughness thereof, Ra was 0.22 μm and Rz was 2.42 μm, respectively.

Using the stainless steel substrate, a polyimide intermediate layer (adhesive-free type and 10 μm thick) and a copper alloy foil (18 μm thick) were laid so that a laminated body was manufactured. As a result, there was obtained a hard disk drive suspension material of the invention.

The adhesive strength between the conductive metal layer and the polyimide intermediate layer in the laminated body was 1.7 kN/m, which was then retained in a constant-temperature and constant-humidity oven (at 80 degrees C., and 80% humidity) for 14 days. As a result, the adhesive strength was changed to 0.9 kN/m, thus indicating that either adhesive strength exceeded 0.5 kN/m and was sufficient.

In other words, it was demons hated that the hard disk drive material obtained herein included all the properties required for a novel hard disk drive suspension material and a hard disk drive of higher capacity and higher transfer rate, since it indicated the sufficient adhesion strength required for a laminated body, having the conductive metal layer as the intermediate layer.

### Second Example

After applying nickel strike plating to a stainless steel foil, silver layer was formed as a conductive metal layer by electroplating method, and thus a stainless steel substrate with one or more conductive metal layers was manufactured.

For electroplating of the conductive metal layer was used the same stainless steel foil coil as the one used in the first example, which was then subjected to degreasing cleaning, nickel strike plating, silver plating, water washing and drying, in sequence. For the nickel strike plating were used Watts bath and sulfamate bath as 50-degree C. plating bath, while for silver plating bath was used silver nitrate bath of normal temperature, containing no brightener as an additive. Current density in the silver plating process was set to 2 A/dm².

As for the thickness of the obtained conductive metal layers of the stainless steel substrate, the nickel plated layer was 0.05 μm thick, while the silver plated layer 1.4 μm thick. As for the surface roughness thereof, Ra was 0.55 μm, and Rz was 2.98 μm, respectively.

Using the stainless steel substrate, a polyimide intermediate layer (adhesive-free type and 10 μm thick) and a copper alloy foil (18 μm thick) were laid so that a laminated body was manufactured. As a result, there was obtained a hard disk drive suspension material of the invention.

The adhesive strength between the conductive metal layer and the polyimide intermediate layer in the laminated body was 1.0 kN/m, which was then retained in the constant-temperature and constant-humidity oven (at 80 degrees C., and 80% humidity) for 14 days. As a result, the adhesive strength was changed to 0.7 kN/m, thus indicating that either adhesive strength exceeded 0.5 kN/m and was sufficient. In other words, it was demonstrated that the hard disk drive material obtained herein included all the properties required for a novel hard disk drive suspension material and a hard disk drive of higher capacity and higher transfer rate, since it indicated the sufficient adhesion strength required for a laminated body, having the conductive metal layer as the intermediate layer.

### Third Example

A stainless steel foil was plated with gold, and thus a stainless steel substrate with one or more conductive metal layers was manufactured.

For electroplating of the conductive metal layer was used a SUS304 stainless steel foil plate as a sample material, which was 20 μm in thickness, 100 μm in width and length, and 0.12 μm in Ra and 0.8 μm in Rz, respectively. The sample material was then subjected to degreasing cleaning, gold plating, water washing and drying, in sequence. For the gold plating was used nitric acid/hydrochloric acid gold solution bath of normal temperature, containing no brightener as an additive. Current density in the gold plating process was set to 1 A/dm².

As for the thickness of the obtained conductive metal layers of the stainless steel substrate, the gold plated layer was 0.15 μm thick, and the surface roughness thereof was 0.88 μm in Ra and 4.48 μm in Rz, respectively.

Using the stainless steel substrate, a polyimide intermediate layer (adhesive-free type and 10 μm thick) and a copper alloy foil (18 μm thick) were laid so that a laminated body was manufactured. As a result, there was obtained a hard disk drive suspension material of the invention.

The adhesive strength between the conductive metal layer and the polyimide intermediate layer in the laminated body was 0.8 kN/m, which was then retained in the constant-temperature and constant-humidity oven (at 80 degrees C., and 80% humidity) for 14 days. As a result, the adhesive strength was changed to 0.6 kN/m, thus indicating that either adhesive strength exceeded 0.5 kN/m and was sufficient. In other words, it was demonstrated that the hard disk drive material obtained herein included all the properties required for a novel hard disk drive suspension material and a hard disk drive of higher capacity and higher transfer rate, since it indicated the sufficient adhesion strength required for a laminated body, having the conductive metal layer as the intermediate layer.

### Fourth Example

A stainless steel foil and a copper foil were subjected to cladding rolling, and then subjected to surface roughening, and thus a stainless steel substrate with one or more conductive metal layers was manufactured.

For cladding rolling, were used a SUS304 stainless steel foil which was 20 μm in thickness, 100 μm in width and length, and a 5 μm-thick copper foil (of the same width and length as the stainless steel foil) and thus a sample material was obtained. The sample material was then subjected to surface roughening treatment, where the sample was retained in blackening reducing agent HT-100 (by Hitachi Chemical Co., Ltd.) at normal temperature for 5 minutes, and then cleaned and dried.

The thickness of the obtained conductive metal layers of the stainless steel substrate was 4.2 μm, and the surface roughness thereof was 0.35 μm in Ra and 2.98 μm in Rz, respectively.

Using the stainless steel substrate, a polyimide intermediate layer (adhesive-free type and 10 μm thick) and a copper alloy foil (18 μm thick) were laid so that a laminated body was manufactured. As a result, there was obtained a hard disk drive suspension material of the invention.

The adhesive strength between the conductive metal layer and the polyimide intermediate layer in the laminated body was 1.6 kN/m, which was then retained in the constant-temperature and constant-humidity oven (at 80 degrees C., and 80% humidity) for 14 days. As a result, the adhesive strength was changed to 1.0 kN/m, thus indicating that either adhesive strength exceeded 0.5 kN/m and was sufficient. In other words, it was demonstrated that the hard disk drive material obtained herein included all the properties required for a novel hard disk drive suspension material and a hard disk drive of higher capacity and higher transfer rate, since it indicated the sufficient adhesion strength required for a laminated body, having the conductive metal layer as the intermediate layer.

### First Comparative Example

A laminated body of a laminated structure was manufactured according to the same method as the first example, except that no nickel strike plating was performed, and current density was set to 1 A/dm².

As for the thickness of the obtained conductive metal layers of the stainless steel substrate, the copper plated layer was 0.07 μm thick, and the surface roughness thereof was 0.20 μm in Ra and 2.22 μm in Rz, respectively.

Using the stainless steel substrate, a polyimide intermediate layer (adhesive-free type and 10 μm thick) and a copper alloy foil (18 μm thick) were laid so that a laminated body was manufactured. As a result, there was obtained a hard disk drive suspension material of the comparative example.

The adhesive strength between the conductive metal layer and the polyimide intermediate layer was too small to evaluate the same.

### Second Comparative Example

A laminated body of a laminated structure was manufactured according to the same method as the first example, except that copper sulfate bath containing brightener as additive was used for copper plating when electroplating pure copper as the conductive metal layer. About 0.05 percent by mass of New Kuppelight 1000 and 0.1 percent by mass of New Kuppelight 3000 both made by Nihon Kagaku Sangyo Co., Ltd. were each added as a brightener. FIG. 2 shows a SEM image of the copper-plated surface of the stainless steel substrate manufactured according to the present comparative example.

As for the thickness of the obtained conductive metal layers of the stainless steel substrate, the nickel plated layer was 0.05 μm thick, and the copper plated layer was 2.5 μm thick. The surface roughness thereof was 0.03 μm in Ra and 0.67 μm in Rz, respectively.

Using the stainless steel substrate, a polyimide intermediate layer (adhesive-free type and 10 μm thick) and a copper alloy foil (18 μm thick) were laid so that a laminated body was manufactured. Thus way, a hard disk drive suspension material of the comparative example was obtained. The adhesive strength between the pure copper layer as the conductive metal layer and the polyimide intermediate layer varied widely from 0.7 to 1.4 kN/m, which was then retained in the constant-temperature and constant-humidity oven (at 80 degrees C., and 80% humidity) for 14 days. As a result, the adhesive strength fell to 0.3 to 0.5 kN/m.

As is apparent from the above, the advantageous effect recognized in the first to fourth examples of the present invention could not be obtained because the first comparative example failed to satisfy the requirement for the thickness of the conductive metal layers of the present invention, and the second comparative example also failed to satisfy the requirement for the surface roughness of the present invention.

1. A stainless steel substrate with one or more conductive metal layers provided on a stainless steel base, wherein said one or more conductive metal layers have a total thickness ranging from 0.1 to 10 μm, a centerline average surface roughness Ra from 0.05 to 1 μm, and a ten-point average surface roughness Rz from 1 to 5 μm, respectively.

2. The stainless steel substrate according to claim 1, wherein said one or more conductive metal layers comprise at least one metal layer primarily composed of at least one metal having electric resistivity of 20 μΩcm or less.

3. The stainless steel substrate according to claim 1, wherein said one or more conductive metal layers comprise at least one metal layer primarily composed of at least one metal selected from a group consisting of copper, nickel, silver, gold, aluminum, tin and zinc.

4. The stainless steel substrate according to claim 1, wherein said one or more conductive metal layers comprise a first metal layer primarily composed of copper and a second metal layer primarily composed of a conductive metal other than copper.

5. The stainless steel substrate according to claim 1, wherein said stainless steel base comprises a stainless steel foil having a thickness of 100 μm or less.

6. The stainless steel substrate according to claim 1, wherein said conductive metal layers comprise a plated layer of at least one conductive metal.

7. The stainless steel substrate according to claim 6, wherein said plated layer comprises a plating of at least one metal selected from a group consisting of copper, nickel, silver, gold, aluminum, tin, zinc and an alloy containing any of them.

8. The stainless steel substrate according to claim 6, wherein said plated layer comprises a plating of metal primarily composed of copper.

9. The stainless steel substrate according to claim 1, wherein said conductive metal layers comprise a strike plating layer and a plated layer of at least one conductive metal.

10. The stainless steel substrate according to claim 9, wherein said strike plating layer comprises a plating of at least one metal selected from a group consisting of copper, nickel, silver, gold, aluminum, tin and zinc.

11. The stainless steel substrate according to claim 9, wherein said conductive metal layers comprise one metal primarily composed of copper.

12. The stainless steel substrate according to claim 6, wherein said plated layer is an electroplated one.

13. The stainless steel substrate according to claim 9, wherein said plated layer is an electroplated one.

14. The stainless steel substrate according to claim 6, wherein said stainless steel base comprises a stainless steel foil having a thickness of 100 μm or less.

15. The stainless steel substrate according to claim 9, wherein said stainless steel base comprises a stainless steel foil having a thickness of 100 μm or less.

16. The stainless steel substrate according to claim 1, wherein said conductive metal layers comprise one or more conductive metal foils composed of at least one conductive metal, said one or more conductive metal foils being rolled onto a surface of said stainless steel base by a cladding rolling treatment, and wherein said surface roughness is that of a top surface of said metal foils.

17. The stainless steel substrate according to claim 16, wherein said conductive metal foils comprise at least one metal foil composed of at least one metal selected from a group consisting of copper, nickel, silver, gold, aluminum.

18. The stainless steel substrate according to claim 16, wherein said conductive metal foils comprise a metal foil primarily composed of copper.

19. The stainless steel substrate according to claim 16, wherein said stainless steel base comprises a stainless steel foil having a post-cladding-rolling thickness of 100 μm or less.

20. A hard disk suspension material comprising a laminated structure formed by laying an insulating layer and a metal foil layer in that order on said conductive metal layer of said stainless steel substrate according to claim 2.

21. A hard disk suspension material comprising a laminated structure formed by laying an insulating layer and a metal foil layer in that order on said conductive metal layer of said stainless steel substrate according to claim 3.

22. A hard disk suspension material comprising a laminated structure formed by laying an insulating layer and a metal foil layer in that order on said conductive metal layer of said stainless steel substrate according to claim 4.

23. A hard disk suspension material comprising a laminated structure formed by laying an insulating layer and a metal foil layer in that order on said conductive metal layer of said stainless steel substrate according to claim 5.

24. A hard disk suspension material comprising a laminated structure formed by laying an insulating layer and a metal foil layer in that order on said conductive metal layer of said stainless steel substrate according to claim 6

25. A hard disk suspension material comprising a laminated structure formed by laying an insulating layer and a metal foil layer in that order on said conductive metal layer of said stainless steel substrate according to claim 9.

26. A hard disk suspension material comprising a laminated structure formed by laying an insulating layer and a metal foil layer in that order on said conductive metal layer of said stainless steel substrate according to claim 16.

27. The hard disk suspension material according to claim 22, wherein said insulating layer comprises a single layer, said single layer being composed of polyimide-based resin only, or resin primarily composed of polyimide-based resin.

28. The hard disk suspension material according to claim 24, wherein said insulating layer comprises a single layer, said single layer being composed of polyimide-based resin only, or resin primarily composed of polyimide-based resin.

29. The hard disk suspension material according to claim 25, wherein said insulating layer comprises a single layer, said single layer being composed of polyimide-based resin only, or resin primarily composed of polyimide-based resin.

30. The hard disk suspension material according to claim 26, wherein said insulating layer comprises a single layer, said single layer being composed of polyimide-based resin only, or resin primarily composed of polyimide-based resin.

31. The hard disk suspension material according to claim 22, wherein said insulating layer comprises multiple layers, said multiple layers comprising a first layer composed of polyimide-based resin only and a second layer primarily composed of polyimide-based resin.

32. The hard disk suspension material according to claim 24, wherein said insulating layer comprises multiple layers, said multiple layers comprising a first layer composed of polyimide-based resin only and a second layer primarily composed of polyimide-based resin.

33. The hard disk suspension material according to claim 25, wherein said insulating layer comprises multiple layers, said multiple layers comprising a first layer composed of polyimide-based resin only and a second layer primarily composed of polyimide-based resin.

34. The hard disk suspension material according to claim 26, wherein said insulating layer comprises multiple layers, said multiple layers comprising a first layer composed of polyimide-based resin only and a second layer primarily composed of polyimide-based resin.

35. A hard disk suspension obtained by working and forming the hard disk suspension material as set forth in claim 27.

36. A hard disk suspension obtained by working and forming the hard disk suspension material as set forth in claim 28.

37. A hard disk suspension obtained by working and forming the hard disk suspension material as set forth in claim 29.

38. A hard disk suspension obtained by working and forming the hard disk suspension material as set forth in claim 30.

39. A hard disk suspension obtained by working and forming the hard disk suspension material as set forth in claim 31.

40. A hard disk suspension obtained by working and forming the hard disk suspension material as set forth in claim 32.

41. A hard disk suspension obtained by working and forming the hard disk suspension material as set forth in claim 33.

42. A hard disk suspension obtained by working and forming the hard disk suspension material as set forth in claim 34.
